(19) United States
(12) Patent Application Publication
(10) Pub. No.: US 2009/0033318 A1
(43) Pub. Date: Feb. 5, 2009

(54) Magnetic Sensing Device with an Elastic Balance Member

(76) Inventor: Hong-Chun TENG, Taichung (TW)

Correspondence Address: Dr. BANGER SHIA, 102 Lindencrest Ct., Sugar Land, TX, 77479-5201, US

(21) Appl. No.: 11/833,944

(22) Filed: Aug. 3, 2007

(51) Int. Cl. G01B 7/00

(52) U.S. Cl. 324/207.22

(57) ABSTRACT

A magnetic sensing device with an elastic balance member comprises a magnetic ruler, a sensing head and an elastic balance member. The sensing head is parallelly moveable relative to the magnetic ruler, the elastic balance member is movably assembled on the sensing head by assembly portions, such that the elastic balance member provides a buffering effect to absorb the impact force, pulling force or pushing force during the displacement of the sensing head. In addition, the elastic balance member further formed with a turning portion with a predetermined curvature, which is connected to the assembly portion and can strengthen the structure of the elastic balance member to make the elastic balance member strong enough to resist pressure.

### BACKGROUND OF THE INVENTION

1. Field of the Invention

The present invention relates to a magnetic sensing device, and more particularly to a magnetic sensing device with an elastic balance member.

2. Description of the Prior Art

Currently, to improve the precision during working, tool machines are usually mounted with a magnetic sensing device 10 having a magnetic ruler 11 and a sensing head 12, as shown in FIG. 1, and the magnetic ruler 11 is located a distance from the sensing head 12, such that the sensing head 12 is parallelly moveable relative to the magnetic ruler 11. However, when in use, the conventional magnetic sensing device 10 still has the following disadvantages:

The sensing head 12 is a follower assembly and can only be moved by the tool machine, but the tool machine is likely to produce vibration when working, which will cause deviation of the sensing head 12 and affect the sensing path, so that the magnetic sensing device 10 cannot sense precisely, thus affecting the positioning accuracy. Moreover, if more tool machines are provided with the magnetic sensing device 10, it should take a lot of time and labor to perform the error adjustment.

The present invention has arisen to mitigate and/or obviate the afore-described disadvantages.

### SUMMARY OF THE INVENTION

The primary objective of the present invention is to provide a magnetic sensing device with an elastic balance member which can provide a buffering effect to absorb the impact force and maintain the positioning accuracy of the magnetic sensing device.

To achieve the object of the present invention, the magnetic sensing device with an elastic balance member comprises a magnetic ruler, a sensing head and an elastic balance member. The sensing head includes a sensing member and a linkage member. The elastic balance member is made of rigid elastic material and is formed with at least two assembly portions, the elastic balance member is mounted between the sensing member and the linkage member and can be movably assembled on the sensing member and the linkage member by the assembly portions, and the elastic balance member further formed with a turning portion with a predetermined curvature that is connected to the assembly portions, respectively. By such arrangements, the turning portion can strengthen the structure of the elastic balance member, such that the sensing member and the follower member of the sensing head can be movably assembled via the elastic balance member. And cooperates with the elasticity of the elastic balance member, the elastic balance assembly provides a buffering effect to absorb the impact force, pulling force or pushing force caused during the displacement, so as to improve the positioning accuracy of the elastic balance member.

The second objective of the present invention is to provide a magnetic sensing device with an elastic balance member which can prevent the foreign objects from blocking the sensing path of the magnetic sensing device.

The magnetic sensing device with an elastic balance member in accordance with the present invention comprises a magnetic ruler, a sensing head, an elastic balance member and a dust proof element. The sensing head includes a sensing member and a linkage member. The elastic balance member is made of rigid elastic material and is formed with at least two assembly portions, the elastic balance member is mounted between the sensing member and the linkage member and can be movably assembled on the sensing member and the linkage member by the assembly portions, and the elastic balance member further formed with a turning portion that is connected to the assembly portions, respectively. The dust proof element includes a containing space for containing the magnetic ruler, and the sensing member of the sensing head is located correspondingly to the magnetic ruler and is inserted in the containing space. The dust proof element is defined with a hole located correspondingly to the containing space, and the elastic balance member is inserted in the hole. Thereby, the dust proof element covers the sensing member and the magnetic ruler, so as to prevent the foreign objects from blocking the sensing path of the magnetic sensing device.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional magnetic sensing device;

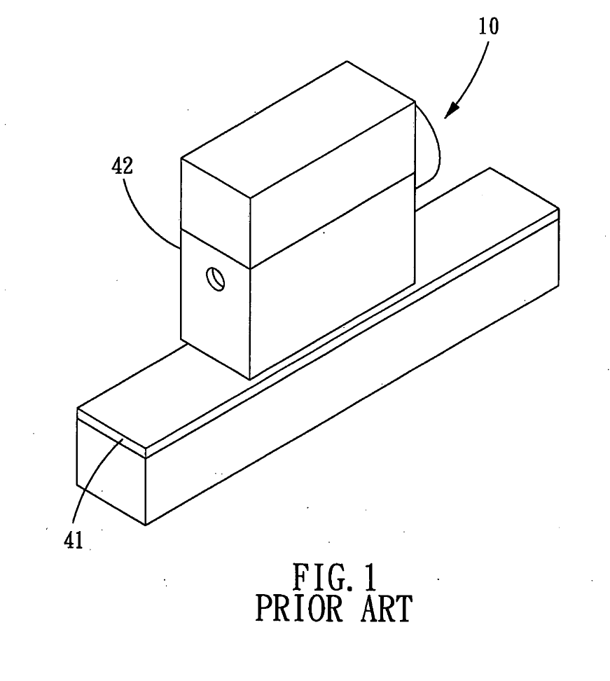

FIG. 2 is an illustrative view of showing a sensing member of a sensing head without guiding wheels in accordance with the present invention;

FIG. 3 is an illustrative view of showing an elastic balance member in accordance with the present invention;

FIG. 4 is a side view of FIG. 3;

FIG. 5 is a front view of FIG. 3;

FIG. 6 is an illustrative view of showing the sensing member of the sensing head mounted with guiding wheels in accordance with the present invention;

FIG. 7 is a side view of FIG. 6; and

FIG. 8 is a front view of FIG. 6.

### DETAILED DESCRIPTION OF THE PREFERRED EMBODIMENTS

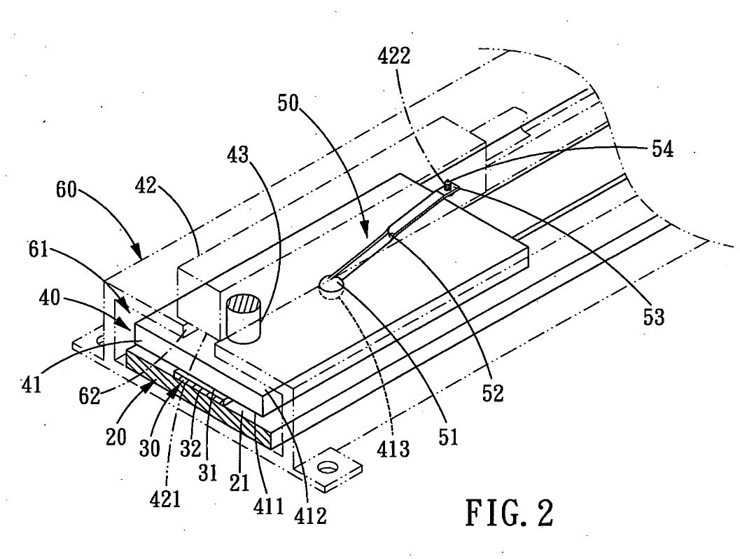

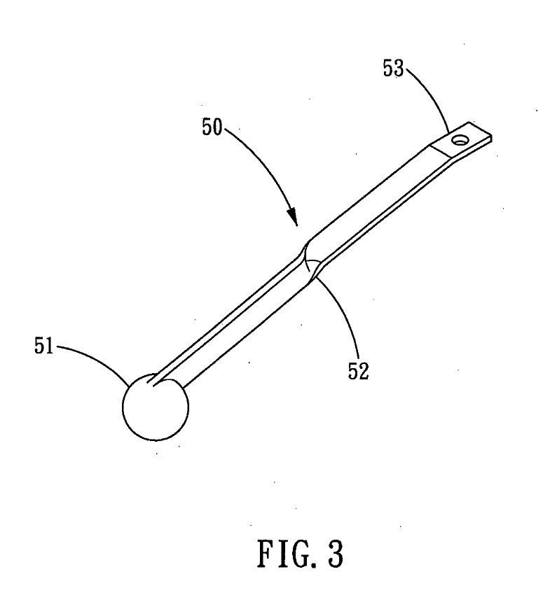

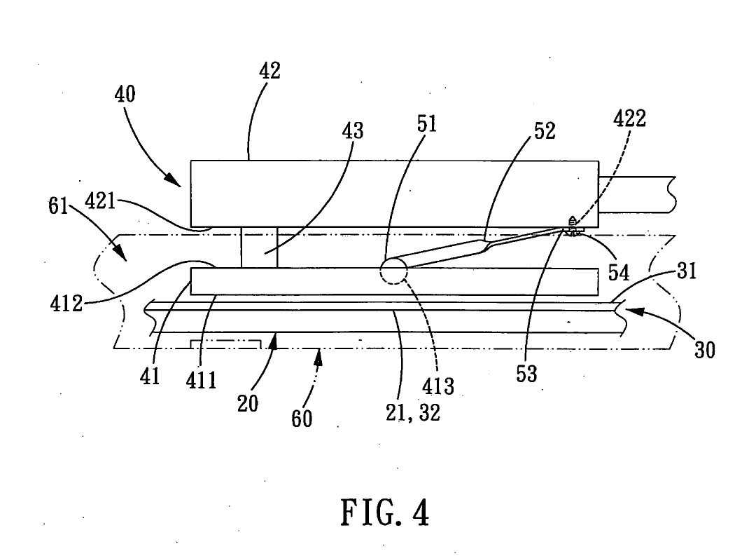

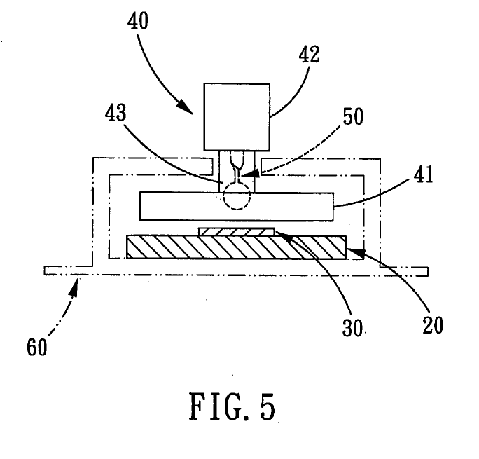

Referring to FIGS. 2-5, a magnetic sensing device with an elastic balance member in accordance with the present invention comprises a base 20, a magnetic ruler 30, a sensing head 40, an elastic balance member 50 and a dust proof element 60.

The base 20 is rectangular block-shaped, and at a top side of the base is formed a bearing surface 21.

The magnetic ruler 30 is rectangular sheet-shaped, one side of the magnetic ruler 30 is formed with an induction surface 31, and the other side of the magnetic ruler 30 is formed with a joint surface 32 to be assembled to the bearing surface 21.

The sensing head 40 includes a sensing member 41, a follower member 42 and a linkage member 43.

The sensing member 41 is rectangular sheet-shaped, at one side of the sensing member 41 is formed an induction surface 411 located correspondingly to the induction surface 31 of the magnetic ruler 30, and the other side of the sensing member 41 is formed with a connecting surface 412 and an engaging hole 413 in a center of the connecting surface 412. Both sides of the sensing member 41 are pivotally mounted with two guiding wheels 414 respectively, the diameter of each guiding wheel 414 is bigger than the thickness of the sensing member 41, and the distance between the opposite guiding wheels 414 is bigger than the width of the induction ruler 30.

The follower member 42 is rectangular sheet-shaped and is formed with a combining surface 421 located correspondingly to the connecting surface 412, and in a rear end of the combining surface 421 is defined a threaded hole 422.

The linkage member 43 is column-shaped, one end of the linkage member 43 is assembled in a front portion of the combining surface 421 of the follower member 42, and the other end of the linkage member 43 is assembled in a rear portion of the connecting surface 412 of the sensing member 41, such that the follower member 42 is located a distance from the sensing member 41. Moreover, the linkage member 43, the engaging hole 413 of the connecting surface 412 and the threaded hole 422 of the combining surface 421 are located at the same axis.

The elastic balance member 50 is sheet-shaped and is made of rigid elastic material, one end of the elastic balance member 50 is formed with a ball-shaped first assembly portion 51 located correspondingly to the engaging hole 413 of the connecting surface 412 of the sensing member 41. A turning portion 52 with a predetermined curvature is formed in a mid portion of the elastic balance member 50 and is connected to the first assembly portion 51, and the other end of the elastic balance member 50 is formed with a sheet-shaped second assembly portion 53 which is also connected to the turning portion 52. In addition, the second assembly portion 53 is fixed to the threaded hole 422 of the combining surface 421 of the follower member 42 by a positioning member 54.

The dust proof element 60 is rectangular hollow-shaped in cross section and includes a containing space 61 having two open ends thereof, and the base 20 and the magnetic ruler 30 are positioned at the bottom of the containing space 61, respectively. The sensing member 41 of the sensing head 40 is located correspondingly to the magnetic ruler 30 and is inserted in the containing space 61. In a top side of the dust proof element 60 is defined a hole 62 correspondingly to the containing space 61, and the linkage member 43 of the sensing head 40 and the elastic balance member 50 are inserted in the hole 62, respectively.

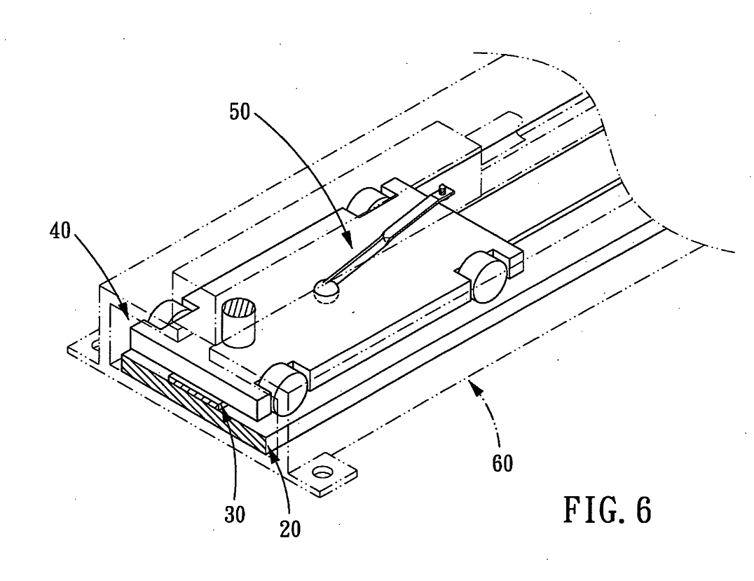

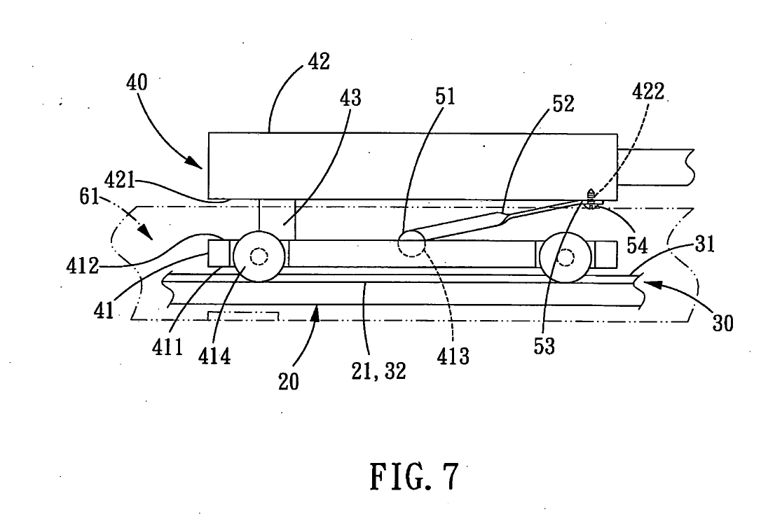

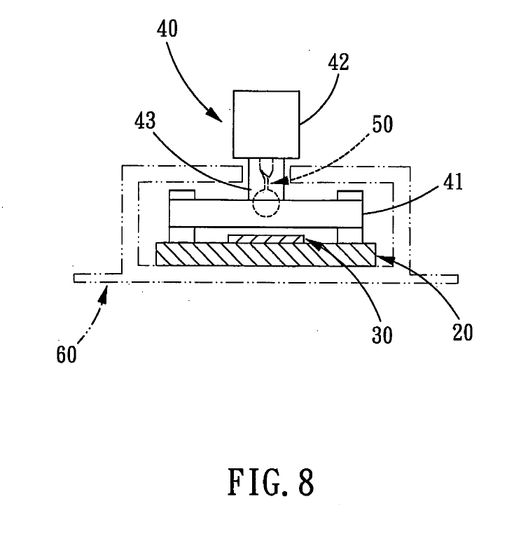

Referring to FIGS. 6-8, both sides of the sensing member 41 are pivotally mounted with two guiding wheels 414 respectively, the diameter of each guiding wheel 414 is bigger than the thickness of the sensing member 41, and the distance between the opposite guiding wheels 414 is bigger than the width of the induction ruler 30.

For a better understanding of the present invention, its operations and functions, reference should be made to FIGS. 2-8 again:

When in use, firstly both ends of the linkage member 43 are fixed on the front portions of the combining surface 421 of the follower member 42 and the connecting surface 412 of the sensing member 41, respectively, and then the first assembly portion 51 of the elastic balance member 50 is rotatably disposed in the engaging hole 413 of the connecting surface 412 of the sensing member 41. In addition, the second assembly portion 53 of the elastic balance member 50 is fixed in the threaded hole 422 of the combining surface 421 of the follower member 42 by the positioning member 54.

The sensing member 41 of the sensing head 40 without the guiding wheels 414, as shown in FIGS. 2-5, is inserted in the containing space 61 of the dust proof element 60 in such a manner that the sensing surface 411 of the sensing member 41 is located a distance from the induction surface 31 of the magnetic ruler 30. At the same time, the linkage member 43 is inserted in the hole 62 of the dust proof element 60 in such a manner that the follower member 42 of the sensing head 40 is exposed out of the dust proof element 60. The follower member 42 is driven by a processing machine to drive the sensing member 41 via the linkage member 43, such that the sensing surface 411 of the sensing member 41 moves in the containing space 61 of the dust proof element 60 to sense the induction surface 31 of the magnetic ruler 30. The elastic balance member 50 assembled between the sensing member 41 and the follower member 42 provides a buffering effect to absorb the impact force caused during the displacement of the sensing head 40, and the first assembly portion 51 of the elastic balance member 50 and the sensing member 41 are movably connected to each other such that it can absorb the pulling force or pushing force produced by them during the displacement by movable assembly. And this buffering effect can maintain the sensing path of the sensing head 40 relative to the magnetic ruler 30. Further, the turning portion 52 can strengthen the structure of the elastic balance member 50 to make the elastic balance member 50 strong enough to resist pressure, so as to improve the positioning accuracy of the magnetic sensing device. In addition, the sensing surface 411 of the sensing member 41 of the sensing head 40 is covered by the dust proof element 60, so as to prevent the foreign objects from blocking the sensing path.

Referring to FIGS. 6-8, both sides of the sensing member 41 are pivotally mounted with two guiding wheels 414 respectively, and the sensing member 41 is rolled on the base 20 relative to the magnetic ruler 30, so as to improve the stability of the sensing member 41 of the sensing head 40 during displacement.

To summarize, a magnetic sensing device with an elastic balance member of the present invention comprises a magnetic ruler, a sensing head and an elastic balance member. The sensing head is parallelly moveable relative to the magnetic ruler, the elastic balance member can be movably assembled on the sensing head by assembly portions, such that the elastic balance member provides a buffering effect to absorb the impact force caused during the displacement of the sensing head. In addition, the elastic balance member further formed with a turning portion with a predetermined curvature, which is connected to the assembly portion and can strengthen the structure of the elastic balance member to make the elastic balance member strong enough to resist pressure.

While we have shown and described various embodiments in accordance with the present invention, it should be clear to those skilled in the art that further embodiments may be made without departing from the scope of the present invention.

1. A magnetic sensing device with an elastic balance member, comprising:
a sensing head having a sensing member and a linkage member, the sensing member being located a distance from the linkage member; and
an elastic balance member formed with a turning portion with a predetermined curvature and at least two assembly portions connected to the turning portion, the elastic balance member being mounted between the sensing member and the linkage member and movably assembled on the sensing member and the linkage member by the assembly portions.

2. The magnetic sensing device with an elastic balance member as claimed in claim 1 further comprising a magnetic ruler located correspondingly to the sensing member of the sensing head.

3. The magnetic sensing device with an elastic balance member as claimed in claim 1, wherein:
in one side of the sensing member of the sensing head is defined an engaging hole, one side of a follower member of the sensing head is defined with a threaded hole, the sensing head further includes the linkage member, one end of the linkage member is assembled on an opposite side of the engaging hole of the sensing member, and the other end of the linkage member is assembled on the opposite side of the threaded hole of the follower member, such that the linkage member, the engaging hole of the sensing member and the threaded hole of the follower member are located at a same axis;
one end of the elastic balance member is formed with a ball-shaped first assembly portion located correspondingly to the engaging hole of the sensing member and connected to the turning portion of the elastic balance member, the other end of the elastic balance member is formed with a sheet-shaped second assembly portion connected to the turning portion, the second assembly portion is fixed to the threaded hole of the follower member by a positioning member.

4. The magnetic sensing device with an elastic balance member as claimed in claim 3 further comprising a dust proof element, wherein the dust proof element has a containing space for containing a magnetic ruler, the sensing member of the sensing head is inserted in the containing space located correspondingly to the magnetic ruler, the dust proof element is defined with a hole located correspondingly to the containing space, and the linkage member of the sensing head and the elastic balance member are inserted in the hole, respectively.

5. The magnetic sensing device with an elastic balance member as claimed in claim 3, wherein both sides of the sensing member are pivotally mounted with two guiding wheels, respectively, a diameter of each guiding wheel is bigger than a thickness of the sensing member, and a distance between the guiding wheels is bigger than a width of the induction ruler.
